(19) United States
(12) Patent Application Publication
(10) Pub. No.: US 2008/0152820 A1
(43) Pub. Date: Jun. 26, 2008

(54) Detachable Protecting Films

(75) Inventors: Helmut Witteler, Wachenheim (DE); Ralf Friedrich, Wiesloch (DE); Walter Bertkau, Ludwigshafen (DE); Michael Ehle, Ludwigshafen (DE)

Correspondence Address: CONNOLLY BOVE LODGE & HUTZ LLP, 1875 EYE STREET, N.W., SUITE 1100, WASHINGTON, DC, 20036, US

(73) Assignee: BASF Aktiengesellschaft, Ludwigshafen (DE)

(21) Appl. No.: 11/816,790

(22) PCT Filed: Feb. 24, 2006
(86) PCT No.: PCT/EP2006/060274

§ 371 Date: Aug. 21, 2007

(30) Foreign Application Priority Data
Feb. 25, 2005 (DE) 102005009165.2

(51) Int. Cl. B05D 1/36; C08L 23/06; B05D 7/14

(52) U.S. Cl. 427/409; 525/240; 427/407.1; 428/220

(57) ABSTRACT

Peelable polymeric protective films on surfaces, in particular on metallic surfaces, which exhibit an oxygen gradient, and a process for producing such protective films. The films are particularly suitable for providing surfaces with temporary protection.

The invention relates to peelable polymeric protective films on surfaces, in particular on metallic surfaces, which exhibit an oxygen gradient, and also to a process for producing such protective films. The films are especially suitable for providing surfaces with temporary protection.

Peelable films are known in principle. The term “peelable film” is used for polymer films which can be peeled by hand as a whole or in large sections from surfaces. In this context it is possible in particular to do without the use of scrapers and other tools which could damage the surface. Peelable films can be used in order to provide surfaces with temporary protection against environmental influences, during transit or storage for example. The subsequent peeling serves to re-establish an optically high-quality surface. On metallic surfaces, the peelable film also serves to maintain a certain chemical composition of the oxidic surface layers, so that after the film is peeled the surfaces can be further processed by painting and other coating techniques without further pretreatment steps. Peelable films can be placed in the ready-made state over substrates, or can be produced actually on the substrate by filming from a liquid coating material.

Films for the temporary protection of surfaces are known in principle.

U.S. Pat. No. 4,693,909 discloses a protective film for metallic surfaces that comprises an ethylene-acrylic acid copolymer having an ethylene content of 75% to 92% by weight. The degree of neutralization of the carboxyl groups is 50 to 100 mol %. The film can be applied by spray application of an aqueous formulation. However, it is not peelable, but instead is removed using hot water.

WO 98/10023 discloses the use of aqueous polymer dispersions for preventing corrosion to metallic surfaces. The dispersions comprise a polymer of olefins, a monomer having acidic functional groups, and, if appropriate, further monomers, and also comprise a corrosion inhibitor dissolved therein and/or a colorant and, optionally, a UV stabilizer. The polymer preferably comprises 50% to 98% by weight of olefins.

U.S. Pat. No. 5,010,131 discloses an aqueous formulation for applying thermally removable coatings in spray booths. The formulation comprises, alongside water, 10% to 40% by weight of pigment, 5% to 15% by weight of a vinyl acetate copolymer, polyvinyl alcohol, additives, and a foaming agent comprising citric acid and NaHCO₃. The coating is removable with hot water.

U.S. Pat. No. 5,604,282 discloses a peelable film which comprises polyvinyl alcohol, a polyalkyl acrylate, and further additives and auxiliaries.

U.S. Pat. No. 6,360,801 discloses an apparatus for applying self-adhesive sheets to automobile bodies.

U.S. Pat. No. 6,555,615 discloses a composition for producing peelable coatings, which comprises a film-forming polymer having a glass transition temperature of 0 to 40° C. and also an amphoteric compound having an isoelectric point at a pH of 3 to 8. The amphoteric compound may comprise, for example, aminocarboxylic acids.

U.S. Pat. No. 6,811,807 discloses a process for applying a peelable film to a surface, an autobody for example, in which various parts of the area are sprayed with different curable compositions. The specification says nothing at all about the nature of the coating.

None of the cited specifications discloses peelable protective films, especially not peelable protective films on metallic surfaces, which exhibit an oxygen gradient.

It was an object of the invention to provide an improved peelable film which can be produced by application from an aqueous formulation and is readily peelable from metallic and nonmetallic surfaces without assistance from water or solvents. The peelable film ought additionally to impart good corrosion control on metal surfaces.

Accordingly, in a first aspect of the invention, peelable protective films have been found which comprise at least 70% by weight of polymers, based on the total amount of all components of the layer, wherein the polymers comprise at least two different polymers each comprising at least 65% by weight of ethene, the protective film further comprising carbon-attached oxygen, with the proviso that the oxygen content of the protective film increases with increasing distance from the surface.

In a second aspect of the invention, a process has been found for applying peelable protective films to a surface, in which the surface is treated in succession with n aqueous formulations Fᵢ, n being a natural number ≧2 and i being a natural number from 1 to n, and each of the n formulations Fᵢ containing at least one polymer comprising in each case at least 65% by weight of ethene and also carbon-attached oxygen, it being possible for the oxygen to be attached either to the polymer or to additional components of the formulation, with the proviso that the carbon-attached oxygen content of the formulations Fᵢ increases with increasing index i.

Details of the invention now follow:

The peelable film of the invention is disposed on a surface. The shape and material of the surface are not critical here. In particular, however, the surface may be that of sheetlike, curved or irregularly shaped moldings or workpieces. With regard to the material, the surfaces, for example, may be those of plastics, metals or glass. They may also be painted surfaces. With preference they may be metallic surfaces, examples being the surface of iron, steel, zinc, galvanized steel or aluminum, in the form for example of sheets, foils or strips, or else processed metals such as, for example, formed or punched autobodies, bodywork parts, architectural facing components or household appliance claddings. It will be appreciated that they may also comprise assemblies of different materials. Mention may be made by way of example of a window, where both the frame and the glazing are protected with the peelable film of the invention.

The peelable film of the invention comprises at least 70% by weight of polymers, based on the total amount of all components of the layer. The fraction of polymers is preferably at least 80%, more preferably at least 90%, and very preferably at least 95% by weight. The film may also be composed exclusively of polymers.

In accordance with the invention the peelable film comprises oxygen attached chemically to carbon; in other words, physically dissolved elemental oxygen (O₂) and oxygen attached in other ways is not included in the consideration. The oxygen is preferably attached to carbon atoms of the polymer comprised in the peelable film. It can, however, also be attached to carbon-containing auxiliaries such as surfactants, for example. It will be appreciated that both may also be the case. In one preferred embodiment the oxygen is attached completely or at least substantially as carbonyl group >C═O, and, more preferably, completely or at least substantially as carboxylate group —COOH and/or salts thereof. “Substantially” is intended to denote that at least 75% by weight of the total carbon-attached oxygen in the peelable film is present in this form, preferably at least 85%, more preferably at least 90%, and very preferably at least 95% by weight.

In accordance with the invention the oxygen content of the peelable film increases with increasing distance from the surface. This increase in oxygen content may be continuous or else discontinuous. The oxygen content of the peelable film, following peeling of the polymer film from the surface if appropriate, can be determined by means of known surface analysis methods, such as, for example, ESCA measurements or IR spectroscopy with glancing incidence. Depth profiles can be produced here in a manner which is likewise known, by means of sputtering, for example. Local fluctuations in concentration are not taken into account in such determinations; instead, the oxygen content is determined, in a manner which is known in principle, as an integral over a representative surface element of the film.

With particular preference the oxygen content of the surface-facing interface of the protective film is less than 6% by weight and that of the surface-remote face is more than 6% by weight.

In accordance with the invention the polymers are at least two different polymers. Preferably they are polymers differing in their amount of carbon-attached oxygen. An oxygen gradient comes about in particular as a result of the nonuniform distribution of the polymers in the layer with, instead, an accretion of the lower-oxygen polymer at the bottom face of the layer and of the oxygen-richer polymer at the top face of the layer.

In accordance with the invention the polymers used each comprise at least 65% by weight of ethene units. They may additionally contain other monomers copolymerizable with ethene. Oxygen-containing polymers can be obtained by preparing them using monomers which contain carbon-oxygen bonds, examples being (meth)acrylic acid or acrylates.

Oxygen-containing polymers can also be obtained, however, by oxidizing polyolefins comprising at least 65% by weight of ethene, polyethylene or polyethylene copolymers for example, in a way which is known in principle. By this means oxygen-containing 20 groups, —COOH groups, —OH groups or >C═O groups for example, are incorporated into the polyolefin.

For preparing the peelable film of the invention it is preferred to use polymers which contain

65% to 99% by weight of ethene,
1% to 35% by weight of monomers copolymerizable with ethene and containing carbon-attached oxygen, and optionally
0 to 30% by weight of further monomers copolymerizable with (A) and (B). The amounts here are based in each case on the total amount of all constituents of the copolymer.

The monomers (B) are ethylenically unsaturated monomers which are copolymerizable with ethene and with the monomers (C) present optionally. They are preferably monoethylenically unsaturated monomers, although it is also possible, optionally, for small amounts of monomers having two or more ethylenically unsaturated groups to be present. The monomers (B) contain carbon-oxygen bonds. The oxygen is attached preferably in the form of carbonyl groups >C═O, more preferably as carboxyl group.

The monomers (B) may, for example, be (meth)acrylic esters or vinyl acetates. The vinyl acetates can also be hydrolyzed wholly or partly after the polymerization to form vinyl alcohol units. The monomers (B) are preferably carboxyl-containing monomers or salts thereof. Preferably 0.5 to 50 mol % of the acid groups present in the polymer have been neutralized. Examples of such monomers comprise acrylic acid, methacrylic acid, crotonic acid, vinyl acetic acid, maleic acid, fumaric acid, itaconic acid, maleic anhydride, or C1 to C4 monoesters of monoethylenically unsaturated dicarboxylic acids. It will be appreciated that mixtures of different monomers (B) can also be used. Particularly preferred monomers are acrylic acid and/or methacrylic acid.

The monomers (C) are monomers different from (A) and (B) but copolymerizable with (A) and (B). It will be appreciated that two or more different monomers (C) may also be used. The monomers (C) may on the one hand be other olefins. Examples of olefins comprise propene, 1-butene, 2-butene, 1-pentene, 1-hexene, 1-heptene or 1-octene. They may additionally be acidic monomers which, however, contain no carbon-oxygen bonds. Examples comprise vinylsulfonic acid, allylsulfonic acid or vinylphosphonic acid.

To apply the peelable film, the surface is treated in succession with n aqueous formulations Fᵢ. i here is a serial index from 1 to n which represents the sequence of treatment steps. In the first step, therefore, the formulation F₁ is used, in the second, formulation F₂, and in the nth step formulation Fₙ. At least two treatment steps are carried out; n, therefore, stands for a natural number ≧2. In general n is 2 to 5, preferably 2 or 3 and more preferably 2.

The formulations are aqueous formulations. Solvents used in this case are in each case preferably only water. The formulations may also comprise, however, small amounts of water-miscible organic solvents. However, at least 50%, preferably at least 70%, and more preferably at least 85% by weight of water is present, relative to the amount of all solvents. Examples of such water-miscible solvents comprise monoalcohols such as methanol, ethanol or propanol, higher alcohols such as ethylene glycol or polyether polyols, and ether alcohols such as butyl glycol or methoxypropanol.

Each of the n formulations Fᵢ comprises at least one of the abovementioned polymers having in each case at least 65% by weight of ethene units. It will be appreciated that the formulations may also each comprise different units. Each formulation further comprises carbon-attached oxygen, it being possible for the oxygen to be attached either to the polymer or to additional components of the formulation. Examples in this context may include surfactants which comprise carbon-oxygen bonds, or cations which can be used to neutralize carboxylate groups. Examples of such cations comprise mono-, di- or triethanolammonium ions, obtained by neutralizing COOH functions with mono-, di- or triethanolamine. Preferably the oxygen is attached to the polymers.

The composition of the formulations Fᵢ is guided further by the proviso that the carbon-attached oxygen content of the formulations Fₙ increases with increasing index n, this datum being based on the sum of all solid constituents of the formulation. In other words, therefore, the surface is first treated with the formulation lowest in oxygen and is treated last with the formulation richest in oxygen.

In one preferred embodiment of the invention, in the first treatment stage with the formulation F₁, a polymer is used which comprises
(A) 90% to 99%, preferably 92% to 98%, by weight of ethene,
(B) 1% to 10%, preferably 2% to 8%, by weight of (meth)acrylic acid, and optionally
(C) 0 to 9% by weight of further monomers.

In a further, preferred embodiment of the invention, in the final treatment stage with the formulation Fₙ, a polymer is used which comprises
(A) 65% to 90%, preferably 70% to 80%, by weight of ethene,
(B) 10% to 35%, preferably 20% to 30%, by weight of (meth)acrylic acid, and optionally
(C) 0 to 9% by weight of further monomers.

It will be appreciated that it is also possible in each case to use a mixture of acrylic acid and methacrylic acid as monomer.

The formulations may also comprise auxiliaries and/or additives beyond the polymers. Examples of such auxiliaries comprise flow control agents, corrosion inhibitors, pigments, release agents, solvents, surfactants, emulsifiers, amines, alkali metal hydroxides or sodium disulfite. The pigments may serve, for example, for coloring or else for other purposes. They may be metallic and nonmetallic in nature. The corrosion inhibitors may also comprise volatile corrosion inhibitors; that is, inhibitors which are able to cross over into the gas phase and so may also exert an effect on uncoated parts, e.g., in cavities.

The formulations of the polymers may be prepared preferably by emulsifying the copolymer in hot water. The emulsifying operation may comprise worksteps under pressure in order to attain temperatures of 100-200° C. Alkalis, hydroxides, and surfactants may be used as auxiliaries for facilitating the operation of emulsification. Preferred amines are ethanolamines, preferred surfactants are fatty alcohol and oxo-process alcohol alkoxylates, especially alkoxylates based on ethene oxide and, if appropriate, propene oxide. Also suitable, however, are other nonionic and ionic surfactants.

The concentration of the formulations is determined by the skilled worker in accordance with the desired coating conditions and with the desired properties of the peelable film. Concentrations which have been found appropriate are from 0.1% to 50% by weight solids relative to the sum of all constituents of the formulation. The solids fraction is preferably 0.25% to 40%, more preferably 0.5% to 30%, and very preferably 1% to 25% by weight.

In one particularly preferred embodiment the concentration of the solids in the formulations employed increases with increasing index i. For the first formulation F₁, concentrations which have been found particularly appropriate in this context are those from 0.1% to 20%, preferably 0.25% to 15%, more preferably 0.5% to 10%, and very preferably 1% to 5% by weight. Concentrations which have been found particularly appropriate for the final formulation, Fₙ, are from 1% to 50%, preferably 2% to 40%, more preferably 5% to 30%, and very preferably 10% to 25% by weight.

Treatment with the formulations for applying the peelable film can take place by immersing the article to be coated in formulations and, preferably, leaving it to drip dry. The formulations may also be applied by spraying, brushing or the like. The solvents can be removed by evaporation at room temperature or at elevated temperatures, particularly temperatures of 30 to 100° C. It is possible here to carry out drying after each of the n treatment steps. Alternatively the layers can be poured on wet on wet. In this case, naturally, a certain mixing of the layers takes place, whereas mixing between the individual layers in the case of full drying is minimal. Hybrid forms, it will be appreciated, are possible. For example, the individual layers can in each case be initially predried under only mild conditions, and the peelable film as a whole can be afterdried later on again, at higher temperatures.

The peelable film is preferably produced from two formulations applied successively. With particular preference the abovementioned preferred formulations F₁ and Fₙ are used for this purpose. Drying may take place in each case at about 70 to 90° C.

The thickness of the peelable protective film is chosen by the skilled worker in accordance with the desired properties. A thickness which has been found particularly appropriate is from 1 to 200 μm, preferably 1 to 100 μm, more preferably 2 to 50 μm, and very preferably 20 to 50 μm.

Peelable films are obtainable by means of the process of the invention that are readily peelable from the surface, especially from metallic surfaces, and that nevertheless ensure very good corrosion control.

The examples below are intended to illustrate the invention:

### EXAMPLE 1

An S235JR steel sheet (DIN EN ISO 10025) is immersed at 20° C. in a formulation 1 (3.5 percent strength solution of a polymer 1 (94% by weight ethene, 3% by weight acrylic acid, 3% by weight methacrylic acid) in water) and dried at 80° C. for 1 h.

The steel sheet is subsequently immersed in a formulation 2 (20 percent strength solution of a polymer 2 (74% by weight ethene, 26% by weight methacrylic acid, partially neutralized) in water) and dried at 80° C. for 1 h.

The film thus produced can be peeled off by hand in one piece and in the DIN 50021 salt spray test provides corrosion control of >50 h.

The results are summarized in Table 1.

### EXAMPLES 2-5; COMPARATIVE EXAMPLES

The experiments were carried out as described above but using different formulations. The details of the formulations used, and also the results, are summarized in Table 1.

The formulations of the polyethylene oxidate described in the examples were prepared by emulsifying 28% by weight of a polyethylene oxidate with an acid number of 22 mg KOH/g and 7% by weight of surfactant (C₁₀ oxo-process alcohol ethoxylate of 1 mol of alcohol and 7 mol of ethene oxide) and 0.6% by weight of potassium hydroxide in water at 150° C. (stirred autoclave) with subsequent dilution. The solid polyethylene oxidate of acid number 22 comprises 1.3% by weight of oxygen. The undiluted surfactant comprises 11% by weight of oxygen.

TABLE 1
Summary of inventive and comparative examples

| | Formulation 1 | | Formulation 2 | | | Salt spray test |
|---|---|---|---|---|---|---|
| | | Concentration | | Concentration | | Corrosion |
| | Polymer | [% by weight] | Polymer | [% by weight] | Peelability | control >50 h |
| Inventive | Copolymer of ethene, | 2% | Copolymer of ethene and acrylic | 10% | yes | yes |
| example 1 | acrylic acid, methacrylic | | acid (80/20), partially neutralized | | | |
| | acid (94/3/3) | | | | | |
| Inventive | Polyethylene oxidate | 1.5% | Copolymer of ethene and | 20% | yes | yes |
| example 2 | | | methacrylic acid (74/26), partially | | | |
| | | | neutralized | | | |
| Inventive | Polyethylene oxidate | 3.5% | Copolymer of ethene and acrylic | 15% | yes | yes |
| example 3 | | | acid (80/20), partially neutralized | | | |
| Inventive | Copolymer of ethene, | 3.5% | Copolymer of ethene and | 20% | yes | yes |
| example 4 | acrylic acid, methacrylic | | methacrylic acid (82/18), partially | | | |
| | acid (94/3/3) | | neutralized | | | |
| Comparative | — | — | Copolymer of ethene and | 20% | no | yes |
| example 1 | | | methacrylic acid (74/26), partially | | | |
| | | | neutralized | | | |
| Comparative | Copolymer of ethene and | 5% | Copolymer of ethene and | 10% | no | yes |
| example 2 | methacrylic acid (74/26), | | methacrylic acid (74/26), partially | | | |
| | partially neutralized | | neutralized | | | |
| Comparative | Polyethylene oxidate | 3.5% | Polyethylene oxidate | 15% | no | no |
| example 3 | | | | | | |

The concentration values specified in the table comprise all nonaqueous constituents of the formulation, i.e., if appropriate, including auxiliaries such as surfactants.

The results show that only layers in which the oxygen content of the layer increases toward the outside are peelable from the surface.

Layers without a concentration gradient are not peelable, irrespective of whether coating has been carried out with a single formulation only or twice with the same polymer.

1. A peelable protective film on a surface, comprising
at least 70% by weight of polymers, based on the total amount of all components of the layer,
wherein the polymers comprise at least two different polymers each comprising at least 65% by weight of ethene, the protective film further comprising carbon-attached oxygen,
with the proviso that the oxygen content of the protective film increases with increasing distance from the surface.

2. The peelable protective film according to claim 1, wherein the polymers each comprise
(A) 65% to 99% by weight of ethene,
(B) 1% to 35% by weight of monomers copolymerizable with ethene and containing carbon-attached oxygen, and
(C) 0 to 30% by weight of further monomers copolymerizable with (A) and (B),
the amounts being based in each case on the sum of all constituents of the polymer.

3. The peelable protective film on a surface according to claim 1, wherein the surface is the surface of a metal.

4. The peelable protective film according to claim 1, wherein the protective film is 1 to 200 μm thick.

5. The peelable protective film according to claim 2, wherein the oxygen is attached to the polymer as a carboxyl group (—COOH) and/or a salt thereof.

6. The peelable protective film according to claim 2, wherein the oxygen content of the surface-facing interface of the protective film is less than 6% by weight and that of the surface-remote face is more than 6% by weight.

7. A process for applying a peelable protective film to a surface, in which the surface is treated with an aqueous polymer formulation, which comprises
treating the surface in succession with n aqueous formulations Fᵢ, n being a natural number ≧2 and i being a natural number from 1 to n, and each of the n formulations Fᵢ containing at least one polymer comprising in each case at least 65% by weight of ethene and also carbon-attached oxygen, it being possible for the oxygen to be attached either to the polymer or to additional components of the formulation,
with the proviso that the carbon-attached oxygen content of the formulations Fᵢ increases with increasing index i.

8. The process according to claim 7, wherein the polymers each comprise
(A) 65% to 99% by weight of ethene,
(B) 1% to 35% by weight of monomers copolymerizable with ethene and containing carbon-attached oxygen, and
(C) 0 to 30% by weight of further monomers copolymerizable with (A) and (B),
the amounts being based in each case on the sum of all constituents of the polymer.

9. The process according to claim 7, wherein n is 2.

10. The process according to claim 7, wherein the surface is the surface of a metal.

11. The process according to claim 7, wherein the protective film is 1 to 200 μm thick.

12. The process according to claim 8, wherein the oxygen is attached to the polymer substantially as a carboxyl group (—COOH) and/or a salt thereof.

13. The process according to claim 8, wherein monomer (B) is (meth)acrylic acid.

14. The process according to claim 13, wherein the polymer in the first formulation used for treating the surface, F₁, is a polymer comprising
(A) 90% to 99% by weight of ethene,
(B) 1% to 10% by weight of (meth)acrylic acid, and optionally
(C) 0 to 9% by weight of further monomers copolymerizable with (A) and (B).

15. The process according to claim 13, wherein the polymer in the last formulation used for treating the surface, Fₙ, is a polymer comprising
(A) 65% to 90% by weight of ethene,
(B) 10% to 35% by weight of (meth)acrylic acid, and optionally
(C) 0 to 9% by weight of further monomers copolymerizable with (A) and (B).

16. The process according to claim 7, wherein the concentration of the polymers in the aqueous formulations Fᵢ increases with increasing index i.

17. The peelable protective film according to claim 2, wherein the surface is the surface of a metal.

18. The peelable protective film according to claim 2, the protective film is 1 to 200 μm thick.

19. The peelable protective film according to claim 3, wherein the protective film is 1 to 200 μm thick.

20. The peelable protective film according to claim 3, wherein the oxygen is attached to the polymer as a carboxyl group (—COOH) and/or a salt thereof.
